(19) United States
(12) Patent Application Publication
(10) Pub. No.: US 2007/0022869 A1
(43) Pub. Date: Feb. 1, 2007

(54) Loudspeaker sensitive sound reproduction

(76) Inventor: Thomas Lechner, Kirchheim (DE)

Correspondence Address: MYERS BIGEL SIBLEY & SAJOVEC, P.A., P.O. BOX 37428, RALEIGH, NC, 27627, US

(21) Appl. No.: 10/570,901

(22) PCT Filed: Sep. 7, 2004
(86) PCT No.: PCT/EP04/09966

§ 371 Date: Mar. 7, 2006

(30) Foreign Application Priority Data
Sep. 25, 2003 (EP) 03021778.0

(51) Int. Cl. G10H 7/00

(52) U.S. Cl. 84/645

(57) ABSTRACT

A reproduction of a music file is modified for adapting a reproduction of the audio data contained in the music file to the characteristic of a small size loudspeaker on a mobile terminal of a wireless communication system so that the audibility of the respective music or polyphonic sound contained in the music file is improved. For example, audio data which represent a sound with a spectral component below the transmission frequency range of the loudspeaker are identified in the music file, and the reproduction of sound from the identified audio data is modified such that the modified sound reproduction yields a sound spectrum having an increased energy content within the transmission frequency range of the loudspeaker as compared to a sound spectrum of an unmodified reproduction. Related apparatus and computer program products are also discussed.

The present invention relates to a reproduction of sound or music files with a small size loudspeaker, particularly with a small size loudspeaker comprised in a mobile terminal of a wireless communication system.

Many mobile terminals, as for instance a Personal Digital Assistant (PDA), a mobile phone, a portable computer or the like, allow to store polyphonic audio data of sound or music for many purposes, e.g. to output acoustical signals, alarm or ringer tones, background sounds for games or for personal entertainment. The sound is reproduced from the audio data by use of one or more types of electroacoustic transducers, whereby it is possible on many appliances to select a particular transducer as e.g. a loudspeaker or an earphone for the reproduction. In the context of this application, the term ‘loudspeaker’ refers to an electroacoustic transducer radiating sound in an open volume, while the term ‘earphone’ denotes an electroacoustic transducer designed to radiate the sound into a small confined volume.

Sound or music data can be stored in different file formats. Two types of files are currently popular. A first type contains sampled audio data in either uncompressed form like a ‘wave’-file or in a compressed form like an ‘mp3’-file. Although the compression reduces the file size by about a magnitude, the very limited storage space on most mobile terminals yet requires smaller sound or music files. This requirement is fulfilled by music score files which store the sound in form of data representing musical notes, instrumentation and articulation information. The most popular respective data format is the MIDI data format.

A MIDI file contains a specification on how the sound is to be rendered. It can be regarded as a sheet of music in an electronically legible format. It contains information about the soundtrack, the devices being used and the acoustical parameters which have to be considered when reproducing the score represented by the data stored in the respective MIDI file. The collective term acoustic parameter denotes statements defining for instance the pitch, the note or rest values, respectively, the loudness level, the tempus, the timbre or special effects like vibrato or reverberation.

To turn a music score file like a MIDI file into sound, the information present in the file has to be interpreted and formed to data representing a sampled, digital sound. For this purpose, a so-called polyphonic synthesiser is used, which renders the score contained in the file to sampled data like e.g. those used in a mono or stereo wave-file. The polyphonic synthesiser may be implemented in software in a digital signal processor or in a separate dedicated hardware.

The rendering of the score is usually based on so-called parameter files like for instance a wave table. A parameter file contains sound samples of an instrument like for instance that of a certain piano in form of digitally sampled data. Each sound sample contains one or more periods of the time representative signal of an instrument to be simulated. Spectral parameter files further keep the frequencies, phases and harmonics of an instrument ready for simulation.

In a different method called FM (Frequency Modulated) synthesis different spectra are used for the synthesis with each spectrum representing a particular instrument to be simulated. The spectra are generated by a sine wave frequency modulated with further sine wave signals, which may again be modulated with still another sine wave signal and so on. The spectra are stored and thus made available in a FM-spectra file.

In mobile terminals, pieces of music are preferably kept in memory in form of MIDI files, as the size of MIDI files is extremely small compared to files containing sampled audio data. A PCM (Pulse Code Modulation) format audio file, like for example a “.wav”-file uses up to 10 Megabyte per minute of music while the same music can be stored in a MIDI file of less than 10 Kilobyte. This is possible, like already mentioned above, since the MIDI file contains only the instructions needed by a polyphonic, so called MIDI synthesiser to reconstruct the respective sound and do not need the sound data itself.

Loudspeakers used in audio applications are expected to reproduce the sound as close as possible to the original sound. This is only possible in the flat response region above the resonance frequency of a loudspeaker where its impedance is nearly ohmic. The lower the resonance frequency of a loudspeaker is, the lower is the lowest frequency which can be reproduced closely to the original. Loudspeakers with a low resonant frequency are typically much larger than the limited space usually available in mobile terminals.

A loudspeaker that fits in the limited space inside a mobile terminal typically has a resonant frequency between about 500 Hz and about 2 kHz. Audio frequencies below the resonant frequency are thereby considerably attenuated when being converted by the loudspeaker into sound. As a result, the bass portion of a composition is cutoff spoiling the pleasure of listening to it considerably.

A loudspeaker with a lower cut-off frequency of about or above 300 Hz is in the ongoing referred to as ‘small size loudspeaker’. The lower cut-off frequency of a loudspeaker is defined as the frequency below which an electrical audio signal is converted with a lower efficiency than one with a frequency above it. It is usually close to the resonance frequency, but not identical with it.

A considerable and very often a major part of the audio energy present in music pieces and polyphonic sounds is found in the lower frequency spectrum. A reproduction of respective audio data with a small size loudspeaker will muffle the sound components in that lower frequency spectrum. The resulting music experience is thus inevitably unpleasant as most of the richness of the sound got lost. In some cases, a piece of music is even rendered unrecognisable.

It is therefore an object of the present invention to improve the audibility of sound represented by audio data of a music file when reproduced by a small size loudspeaker.

The above object is achieved by the invention as defined in the independent claims.

The invention comprises a method for modifying a reproduction of a music file according to a transmission characteristic of a loudspeaker of a mobile terminal of a wireless communication system according to which audio data are identified in the music file which represent a sound with a spectral component below the transmission frequency of the loudspeaker, and according to which a reproduction of sound from the identified audio data is modified such, that the modified reproduction yields a sound spectrum having an increased energy content within the transmission frequency range of the loudspeaker as compared to sound obtained by an unmodified reproduction.

The invention is further represented by an apparatus for rendering sampled data from a music file according to a transmission characteristic of a loudspeaker of a mobile terminal of a wireless communication system, whereby the apparatus contains storage means for storing the music file and data related to the transmission characteristic of one or more loudspeaker, selection means for selecting data for a particular loudspeaker from the storage means, low frequency sound identification means for identifying audio data in the music file which represent a sound with a spectral component below the transmission frequency range of a loudspeaker according to the selected data, control means for controlling a modification of a reproduction of sound from the identified audio data such, that the modified reproduction yields a sound spectrum having an increased energy content within the transmission frequency range of the loudspeaker as compared to sound obtained by an unmodified reproduction, and synthesising means for synthesising sampled data from the modified music score.

The above object is further achieved by a mobile terminal for use with a wireless communication system and adapted to reproduce audio data from a music file, with the mobile terminal comprising an apparatus according to the present invention for rendering sampled data from the music file, a transformation means for transforming the sampled data obtained from the apparatus into a respective analogue electrical signal, and a loudspeaker for converting the analogue electrical signal into a respective sound signal.

Furthermore the above object is achieved by means of a software product comprising a series of state elements which are adapted to be processed by a data processing means of a mobile terminal such, that a method according to one of the claims 1 to 9 may be executed thereon.

The present invention advantageously uses the ability of the human hearing to perceive the fundamental frequency of a complex sound signal even when the fundamental frequency is not part of the audio spectrum received by the ear. Accordingly, a listener is able to virtually hear the correct pitch of a sound as long as the overtones allow the hearing to ‘reconstruct’ the fundamental tone. This peculiarity of the human hearing is called virtual pitch and described e.g. in E. Zwicker and H. Fastl, Psychoacoustics, Facts and Models, Springer Verlag Berlin Heidelberg, N.Y., London, Paris, Tokyo, Hong Kong, Barcelona, 1990, p 110-116. By shifting the main energy of a sound spectrum reproduced from a music file into the transmission range of a loudspeaker, particularly a small size loudspeaker, the human hearing is supported in reconstructing the not audible parts of the sound spectrum. Further, the radiation efficiency of a loudspeaker is increased by emphasising the higher frequency part of a sound spectrum resulting in an improved audibility of the reproduced sound.

Advantageous embodiments of the present invention are the subject of other claims.

In a preferred embodiment of the present invention, the modification of the reproduction is based on the use of a modified parameter file like e.g. a modified wave table containing samples with a frequency spectrum adapted to the transmission frequency range of a small size loudspeaker used. When not using parameter files for the music reproduction but an FM synthesis, the modified reproduction of sound is instead based on a likewise modified FM-spectra file.

The present invention may further be implemented by basing the modification of a reproduction of sound on swapping a specification given in the music file for an instrument used to reproduce sound from the identified audio data by a substitute specification of an instrument with brighter timbre. The instrument of the substitute specification hereby advantageously belongs to the same category of instruments as the originally specified instrument to maintain the characteristics of the arrangement of the replayed piece of music. In a further development, if more than one substitute specification is available for being swapped with an original specification in the music file, the substitute specification is selected based on the register in which the originally specified instrument is to be replayed. By this the reproduction is optimised with respect to peculiarities of particular sequences of a score.

A straightforward modification of a sound reproduction is based on a transposition of a sound spectrum to a higher frequency range for retaining the characteristic of the music score but shifting the main energy content of the sound spectra into the transmission range of the reproducing loudspeaker. This is most effective for the shift interval being adapted to relocate the lower end of the sound spectrum within the transmission frequency range of the loudspeaker.

For achieving a high sound pressure with the loudspeaker, the main energy content of the transposed sound spectrum is effectively located within a frequency range from 5 kHz to 10 kHz.

The format of the music score file preferably corresponds to a MIDI data file format, since this format is the most popular when small size music files are required.

The methods explained for modifying the music score are best put into practice by the control means of the apparatus according to the invention. The control means may further store the modified music score in a music score file in the storage means of the apparatus for reuse with a particular loudspeaker. In a preferred embodiment of the present invention, the control means modifies the music score at the time sampled data are rendered from the music score file.

An adaptation of a reproduction of a music file to the transmission characteristic of an electroacoustic transducer offers the opportunity to reproduce polyphonic compositions with a small size loudspeaker and a sound quality which is comparable to that of a high fidelity transducer. This is particularly relevant for mobile terminals of wireless communication systems which are too small to integrate larger size loudspeakers offering a wide enough transmission range. The small size loudspeakers which are typically used in theses appliances are not capable of reproducing the complex sounds produced by a series of instruments so that it is sometimes hard to recognise a certain piece of music when replayed on the respective mobile terminal.

In the following description, the present invention is explained in more detail with respect to special embodiments and in relation to the enclosed drawings, in which

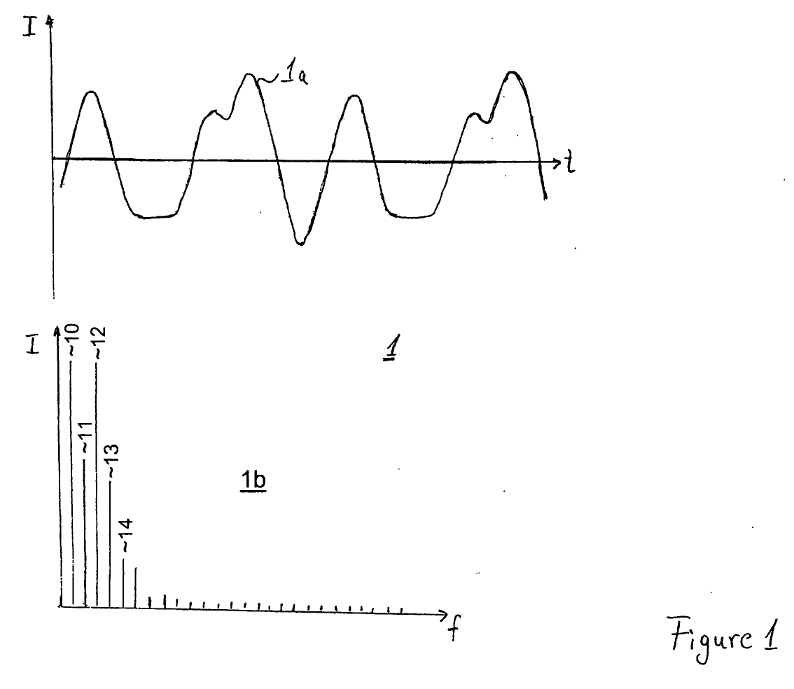

FIG. 1 shows the audio signal of a clarinet in a time and a frequency representation,

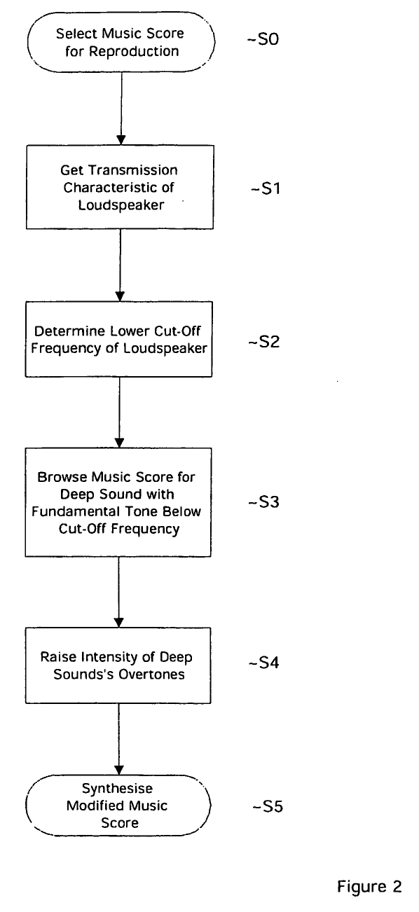

FIG. 2 shows a flow chart of a method according to the present invention,

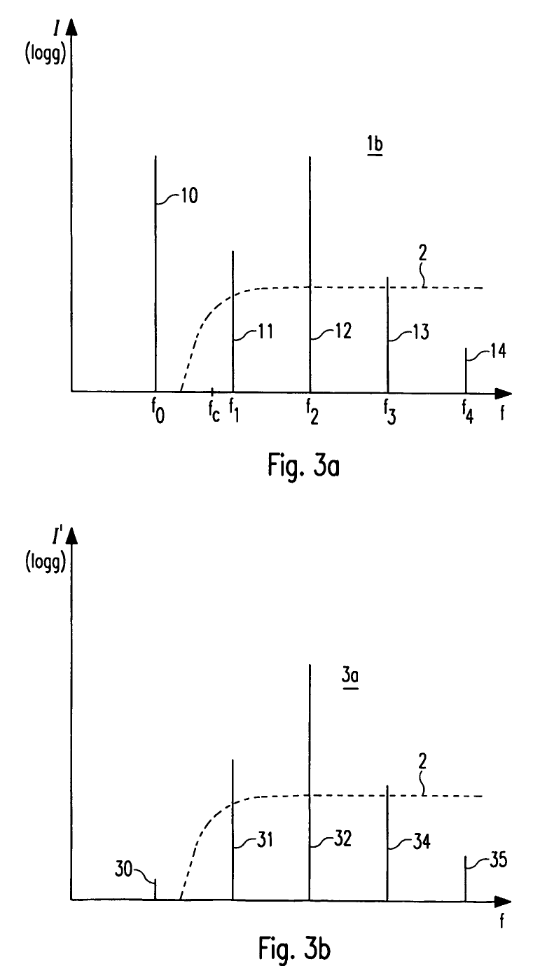

FIG. 3a shows the frequency spectrum of the audio signal according to FIG. 1 in relation to the transmission characteristic of a small size loudspeaker,

FIG. 3b shows the frequency spectrum of a sound signal resulting from converting the audio signal of FIG. 3a with a small size loudspeaker of indicated transmission characteristic,

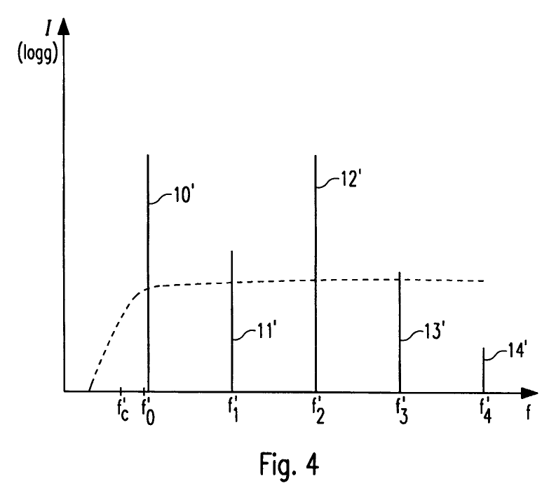

FIG. 4 shows the frequency spectrum of the audio signal of FIG. 3a transposed according to an embodiment of the present invention,

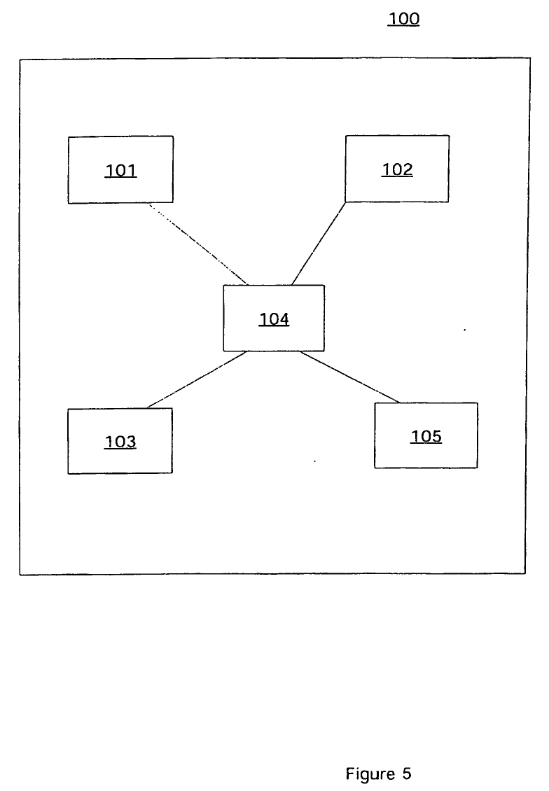

FIG. 5 shows an apparatus according to the present invention.

An audio signal 1 obtained from a clarinet is shown in FIG. 1. The upper representation illustrates the time representation 1a of the audio signal 1 for about two signal periods while the lower diagram shows the associated frequency distribution 1b. It is understood from the representations that the audio signal 1 is composed of a fundamental oscillation 10 superimposed by several harmonics 11, 12, 13, 14 and so on forming a complex tone mixture, a so called sound.

In accordance with the notation used in the relevant literature, a tone denotes a pure sine wave oscillation with a single spectral line. The colloquial expression ‘tone’ refers to a superposition of several sine wave oscillations and is correctly referred to as a ‘sound’ like it is done in this specification. Sound is a strictly periodic event with a discontinuous frequency spectrum. It is composed of a fundamental tone 10 and several overtones 11, 12, 13, 14 etc. having audio frequencies which are an integer multiple of the fundamental audio frequency. The ratio of the fundamental tone intensity to that of each overtones is characteristic for a certain instrument. It defines the timbre or tone colour of the respective instrument. The fundamental frequency of a sound is responsible for the perception of the pitch.

The human ear works like a Fourier analyser performing a harmonic analysis on a sound received. This enables it to deduce the fundamental tone of a sound perceived based on the detected overtones. To some degree the ear is even able to perceive the original sound when the fundamental tone is completely missing in the received audio spectrum. The thus perceived correct pitch of the incompletely received sound is called virtual pitch. A detailed description related to the virtual pitch is given in E. Zwicker and H. Fastl, Psychoacoustics, Facts and Models, Springer Verlag Berlin Heidelberg, N.Y., London, Paris, Tokyo, Hong Kong, Barcelona, 1990, p 110-116.

Without the ability of the human ear to complete a missing spectral component of a sound by a virtual pitch it would not be possible to detect the intonation of a human voice transmitted over a telephone line. The fundamental tones of a human voice, particularly a male one, are outside the transmission frequency range from 300 Hz to 3.4 kHz used for telephone lines. Only the virtual pitch completion enables a human to perceive the intonation of the voice.

One condition to be observed for perceiving a virtual pitch is a sufficient energy content of the audible spectral components of a sound. In other words, when too many of the overtones of a sound are muffled during a reproduction of the sound, the virtual pitch capability of the human ear may not be able to replace the missing part of the audio spectrum.

When reproducing a music score from a music score file, like for instance a MIDI file, with a small size loudspeaker cutting off the low frequency tones, the original richness of the sound can be restored by the human ear if the intensity of the associated overtones is high enough. According to the present invention, the reproduction of a music file containing the score is modified prior to being reproduced according to a method, the basic steps of which are illustrated in the flow chart of FIG. 2.

After selecting from e.g. a memory of a mobile terminal in step S0 a certain music file for reproduction on that mobile terminal which has one or more electroacoustic transducers, data concerning the transmission characteristics of the transducer used for the replay are made available in step S1. If the electroacoustic transducer selected for the replay is a loudspeaker according to the above given definition, the lower cut-off frequency is determined in the following step S2 from the data made available beforehand.

Next, the music score is browsed in step S3 for audio data representing notes corresponding to a low frequency sound, that is a sound with a fundamental tone located below the transmission frequency range of the selected loudspeaker, and thus below its lower cut-off frequency. The reproduction of at least the audio data corresponding to the respective low frequency sounds is then modified in step S4 by defining a reproduction mode which results in an increased energy content of the sound spectrum within the transmission frequency range of the loudspeaker. This can be accomplished by either modifying the content of the audio data itself or by modifying the assignment to parameter or FM files used for synthesising the music file. After modification, the music score is passed on to the polyphonic synthesising process in step S5.

An effective way to modify the reproduction of a music file is to modify the assignment to a parameter file like e.g. a wave table or to a FM-file used for synthesising. These files can be generally referred to as synthesis base files, as both types form a base for interpreting the sound information in the music file by the polyphonic synthesiser. Assumed that a first synthesis base file intended to be used for reproducing a music file with a fidelity close to its original is used for replaying the music file with a small size loudspeaker, then the lower frequency components of the sound will be cut off rendering the replayed music unpleasant or even unbearable.

This effect is shown with respect to FIGS. 3a and 3b. FIG. 3a shows the frequency spectrum 1b comprising the fundamental tone 10 and the first four overtones 11, 12, 13, and 14 of the clarinet sound according to FIG. 1. The representation is given in intensity I versus frequency f of the respective component. The frequencies of the overtones f₁, f₂, f₃, and f₄ each are an integer multiple of the fundamental frequency f₀. The dashed line 2 indicates the transmission characteristic of a small size loudspeaker used for a reproduction of the underlying sound. It is shown in a semi-logarithmic representation of its gain g versus transmission frequency f. FIG. 3b shows the frequency spectrum of the sound as reproduced by a small size loudspeaker in sound pressure intensity I′ versus transmission frequency f. Again, the transmission characteristic 2 of the small size loudspeaker is indicated with a dashed line. As can be seen from the representation, the intensity of the replayed fundamental tone 30 is suppressed with respect to the replayed overtones 31, 32, 33, 34, and 35.

To overcome the sound distortion, a second synthesis base file is provided on the mobile terminal which contains sound samples of brighter timbre. In these samples, the spectral energy of the sounds is in general shifted to the higher harmonics as compared to the samples of the original first synthesis base file. The second synthesis base file is used for synthesising the audio data of the music file each time the music file is replayed with the small size loudspeaker.

Keeping different synthesis base files available advantageously allows to adapt the reproduction of a music file to a variety of loudspeakers with different transmission characteristics. Particularly when using an earphone, the first synthesis base file containing the samples for a high fidelity replay of the music file will be used, while the second synthesis base file with the sound samples of brighter timbre will e.g. be selected for a replay via the hands-free loudspeaker of a mobile terminal.

In a further embodiment of the present invention, the specification given in a music score file for an instrument to be used for reproducing a certain sequence of low frequency sounding notes is swapped for a substitute specification defining a different instrument of brighter timbre for the reproduction. In other words, the registration of an instrument is swapped when the main audio energy is in the fundamental tones for low frequency sounds. As the instrument of the substitute specification has a brighter timbre, its sound energy represented by the overtone spectrum is generally higher than that of the originally registered instrument. Muffled sounding instruments which are registered or specified for a particular sequence are thus replaced by similar but brighter sounding, more crisp instruments. A certain type of piano could for instance be replaced by a brighter one or possibly even a harpsichord.

The respective instrument replacement has not necessarily be carried out throughout the whole music score, but may advantageously be limited to certain voices of the score in which the instruments to be considered are played in a low register. The score is therefore scanned for voices with low notes played on muffled instruments which produce no considerable audio energy in the transmission frequency range of the loudspeaker. Voices in higher registers are then left with the instrument specification unchanged, whereas e.g. a flute in a low voice will be replaced by an oboe to improve the audibility of this voice when reproduced with a small size loudspeaker.

The instrument replacement or re-specification, respectively, is accomplished loudspeaker specifically. That means, that the type of instrument substituting the originally specified instrument depends on the transmission characteristic of the loudspeaker actually used. Hereto a cross reference table is preferably stored on the reproducing device. The cross reference table contains a list of possible substitute instrument specifications for a variety of original instrument specifications, whereby each particular substitute specification is assigned to a loudspeaker with a particular transmission characteristic. As the choice of the best suited replacement instrument depends on the lower cut-off frequency f_{c} of the electroacoustic transducer used for reproducing the score, several replacement or substitute instruments, respectively, are kept in store for an originally registered instrument. Priority is hereby given to replacement instruments belonging to the same category of instruments as the originally specified. If this will not render the expected results, specifications of instruments belonging to the same class will be preferred, e.g. a violin will be used to replace a viola.

In a further favourable embodiment of the present invention the score is adapted as a whole to the transmission characteristic of a small size loudspeaker by transposing it upwards by a certain frequency interval. The frequency interval is substantially defined by the frequency spacing between the fundamental tone of a low frequency sound and the cut-off frequency of the small size loudspeaker. By transposing the music score upwards, all or at least nearly all frequencies in the sound spectrum are shifted upwards into the frequency range of the small size loudspeaker as shown in FIG. 4. The fundamental tone 10 of the original sound spectrum shown in FIG. 3a is shifted in the illustrated example above the lower cut-off frequency f_{c} at the new frequency f′₁. The overtones are shifted accordingly by the same frequency interval f′₁-f₁ to the new locations f′₂, f′₃, and f′₄, respectively. As a result the main energy of the produced sound signal is located within the transmission frequency range of the small size loudspeaker.

The transposition interval may be chosen dependent on the arrangement of the score. Music arranged relatively low will be transposed by a bigger interval than music which is already arranged fairly high with only a few registers showing low frequency sounds.

The present invention is not restricted to only enable a pleasant reproduction of polyphonic scores. Particularly when reproducing polyphonic scores which are used as ringer tones or alarm signals or the like, it is necessary to use the frequency range of the loudspeaker wherein it shows the highest degree of efficiency. Only then are the highest sound pressures possible achieved allowing the respective sound to be reliably perceived even in noisy environments or when the mobile terminal is kept in a pocket or bag. Small size loudspeaker are most efficient in the frequency range of 5 kHz to 10 kHz. Therefore, the reproduction of polyphonic ringer or alarm tones will be modified according to one of the methods described above with the condition, that the main energy content of the thus produced sound spectrum falls within the frequency range from 5 kHz to 10 kHz.

The modification of a music score according to the above specified is implemented by an apparatus 100 shown in FIG. 7. It comprises a storage means 101 for storing one or more music score files e.g. in the form of a MIDI file, data related to the transmission characteristic of one or more electroacoustic transducers like for instance a small size loudspeaker which is available on a reproducing appliance containing the apparatus 100. It may further store data related to the synthesising and related to the reproduction modification process, like for instance the above described cross-reference table or adjusted FM parameter and wave tables.

A selection means 102 is further provided which is adapted to select data concerning the characteristic of a particular electroacoustic transducer chosen by a user for the reproduction of score. Since many mobile terminals provide more than one electroacoustic transducer for sound reproduction, e.g. high fidelity headphones in addition to an earpiece, a small size loudspeaker, or accessories like a desktop stand with a loudspeaker, a user is enabled to pick out one he thinks is best for the given situation. If a user chooses high fidelity headphones for listening to a music score, the selection means 102 will select the data containing the information about the reproduction frequency range of the respective headphones from the storage means 101. As the chosen headphones are capable of reproducing the full audio frequency spectrum, the music score will not be modified but replayed in its original version. When using a small size loudspeaker for replay, the information defining its transmission characteristic is selected from the storage means 101, and the music score reproduction is then modified accordingly.

A music score may contain any type of sound data, like e.g. a polyphonic ringer signal, a signature tune, a piece of music or the like. Music scores serving an indication of a particular function on the appliance are usually pre-assigned to that function by either the user or the manufacturer of the appliance. Others, particularly those which are replayed for entertainment are usually selected manually by a user or downloaded e.g. via WAP (Wireless Application Protocol) for reproduction. When selected for reproduction by one of the described options, a low frequency sound identification means 103 searches the music score file for audio data or notes, respectively, which correspond to a low frequency sound having a fundamental tone of an audio frequency below the transmission frequency range of the beforehand selected loudspeaker.

The modification of sound reproduction according to one of the procedures described above is controlled by the control means 104. After modification according to the data selected previously, the energy content of the sound spectrum is shifted for better overlapping with the transmission frequency range of the loudspeaker. The control means 104 may effectively be realised with a processing means so that the above specified procedures may be implemented in software for being carried out by the control means 104. The final synthesising of the modified and/or unmodified audio or sound data into sampled audio data is accomplished by the synthesising means 105.

The software for implementing the control means 104 may further be kept in a physical autonomous form like on a data carrier or a data stream.

The apparatus 100 is preferably part of a mobile terminal which transforms the sampled audio data produced by the synthesising means 105 into respective analogue electrical signal which are further converted into a corresponding sound signal by a small size loudspeaker of the mobile terminal.

The control means 104 may also use the modification parameter for modifying the audio data present in the music file. The modified audio data can be restored to replace the original audio data in the original music file but preferably a new copy of the music file is created instead in the storage means 101 containing the modified audio data. This file is later reused for replaying the respective piece of music with the respective small size loudspeaker. This solution is particularly preferred for polyphonic signature tunes which are often used on a mobile terminal. As the original copy of the music file is still available on the storage means 101, it is possible to connect HiFi headphones with a wide reproduction frequency range to the mobile terminal and to reproduce the music file without any modification as this would only degrade the possible fidelity. In this case, the original music score is treated to be already optimised for reproduction with the sound spectra as close as possible to the sound of the real instruments.

For most of the music files the modification of the music file reproduction takes preferably place at the time the synthesising means renders sampled data from it. In a further embodiment of the present invention, the modification of the music file may be accomplished in an idle condition of the mobile terminal when only a few of its resources are used. Both methods enable an adaptation of a music file reproduction to the transmission characteristics of a loudspeaker without having to store the same piece of music in different versions on the mobile terminal.

1. A method for modifying a sound reproduction of a music file according to a transmission characteristic of a loudspeaker of a mobile terminal of a wireless communication system, the method comprising:
identifying audio data in the music file which represent a sound with a spectral component below a transmission frequency range of the loudspeaker; and
modifying a sound reproduction of the identified audio data such that the modified sound reproduction yields a sound spectrum having an increased energy content within the transmission frequency range of the loudspeaker as compared to a sound spectrum of an unmodified sound reproduction,
wherein the modified sound reproduction is based on replacing a specification provided in the music file for an instrument used to reproduce sound from the identified audio data with a substitute specification of an instrument with brighter timbre.

2. A method according to claim 1, wherein the instrument of the substitute specification belongs to a same category of instruments as the instrument of the specification provided in the music file.

3. A method according to claim 1, wherein more than one substitute specification is available, and wherein a particular substitute specification is selected based on a register in which the instrument of the specification provided in the music file is to be replayed.

4. A method for modifying a sound reproduction of a music file according to a transmission characteristic of a loudspeaker of a mobile terminal of a wireless communication system, the method comprising:
identifying audio data in the music file which represent a sound with a spectral component below a transmission frequency range of the loudspeaker; and
modifying a sound reproduction of the identified audio data such that the modified sound reproduction yields a sound spectrum having an increased energy content within the transmission frequency range of the loudspeaker as compared to a sound spectrum of an unmodified sound reproduction,
wherein the modified sound reproduction of sound is based on a transposition of frequency data in the music file to a higher frequency range.

5. A method according to claim 4, wherein the transposition shifts the sound spectrum of the modified sound reproduction such that the lower end of the sound spectrum of the modified sound reproduction is located within the transmission frequency range of the loudspeaker.

6. A method according to claim 5, wherein a main energy content of the sound spectrum of the modified sound reproduction is located within a frequency range from about 5 kHz to about 10 kHz.

7. A method according to claim 4, wherein the modified sound reproduction is based on a modified parameter file.

8. A method according to claim 4, wherein the modified sound reproduction is based on a modified FM-spectra file.

9. A method according claim 4, wherein a format of the music file corresponds to a MIDI data file format.

10. An apparatus for rendering sampled data from a music file according to a transmission characteristic of a loudspeaker of a mobile terminal of a wireless communication system, the apparatus comprising:
storage means for storing the music file and data related to transmission characteristics of one or more loudspeakers,
selection means for selecting data for a particular loudspeaker from the storage means,
low frequency sound identification means for identifying audio data in the music file which represent a sound with a spectral component below a transmission frequency range of the particular loudspeaker corresponding to the selected data,
control means for controlling a modification of a sound reproduction from the identified audio data such that the modified sound reproduction yields a sound spectrum having an increased energy content within the transmission frequency range of the particular loudspeaker as compared to a sound spectrum of an unmodified sound reproduction; and
synthesizing means for synthesizing sampled data from a modified music file,
wherein the control means modifies the music file to provide the modified music file by replacing a specification of an instrument provided in the music file for the identified audio data with a substitute specification of an instrument having brighter timbre and/or by transposing frequency data in the music file to a higher frequency range.

11. An apparatus according to claim 10, wherein the control means is configured to store modified audio data representing the modified sound reproduction in a music file in the storage means of the apparatus.

12. An apparatus according to claim 10, wherein the control means is configured to modify the sound reproduction at a time a respective music file is replayed via the loudspeaker.

13. A mobile terminal for use with a wireless communication system and configured to reproduce audio data from a music file, the mobile terminal comprising:
an apparatus according to claim 10 configured to render sampled data from the music file;
a transformation means configured to transform the sampled data obtained from the apparatus into an analog electrical signal; and
a loudspeaker configured to convert the analog electrical signal into a sound signal.

14. A computer program product for modifying a sound reproduction of a music file according to a transmission characteristic of a loudspeaker of a mobile terminal of a wireless communication system, the computer program product comprising:
a computer readable storage medium having computer readable program code embodied therein that is configured to be processed by a data processing means of the mobile terminal to carry out a method according to claim 1.
